(19) United States
(12) Patent Application Publication
(10) Pub. No.: US 2026/0338478 A1
(43) Pub. Date: Oct. 29, 2026

(54) SUPPORTING FRAME FOR A RADIATION SHIELD

(71) Applicant: PLANSEE SE, Reutte (AT)

(72) Inventors: Peter SCHUSTER, Reutte (AT); Sebastian ZERL, Reutte (AT); Peter WEHRMEISTER, Reutte (AT); Bernhard VALENTINI, Reutte (AT); Markus PRILLER, Reutte (AT); Bernhard MAYR-SCHMOELZER, Reutte (AT); Peter MALLAUN, Reutte (AT); Peter LOIDOLT, Reutte (AT); Karl-Heinz LEITZ, Reutte (AT); Markus KLOCKER, Reutte (AT); Bernd KLEINPASS, Reutte (AT); Dirk HANDTRACK, Reutte (AT)

(21) Appl. No.: 19/115,908

(22) PCT Filed: Mar. 14, 2023
(86) PCT No.: PCT/AT2023/060071

§ 371 Date: Mar. 27, 2025

(30) Foreign Application Priority Data
Sep. 27, 2022 (AT) GM 50149/2022

(51) Int. Cl. F27D 1/00

(52) U.S. Cl. CPC F27D 1/0033

(57) ABSTRACT

A support frame for holding a radiation shield for a high-temperature furnace is configured to connect the radiation shield to a wall of the high-temperature furnace and to space the radiation shield from the wall at a normal distance. The supporting frame has at least one holding element which is inclined in relation to a normal distance direction at an angle at least in sections between the radiation shield and the wall and is configured to be rotatable and/or flexible at least in sections in such a way that a lateral expansion of the radiation shield brings about an increase in the angle and therefore a reduction in the normal distance. An arrangement including a cover or a side wall for a high-temperature furnace and a support framework, as well as a high-temperature furnace with a support framework, are also provided.

The present invention relates to a support framework of a radiation shield for a high-temperature furnace having the features of the preamble of claim 1. In the context of this application, a high-temperature furnace refers in particular to a metallic high-temperature furnace.

A metallic high-temperature furnace comprises an outer furnace wall, usually designed as a steel jacket (“casing”). The steel jacket is generally water-cooled. It also includes a process space or charge space, into which a charge material can be introduced. There are heating devices in the process space for heating of the charge material.

In metallic high-temperature furnaces, a process space is thermally insulated with respect to the outer furnace wall generally by means of what is called a radiation shield, which is formed from an essentially parallel arrangement of metal radiator plates that are spaced apart from one another by means of spacers and are especially made of refractory metal, especially tungsten, molybdenum or alloys thereof.

Also known are insulations for high-temperature furnaces based on graphite and ceramic, and also hybrid solutions. An assembly of a shield together with heat conductors is referred to as a hot zone. The construction of a hot zone of a high-temperature furnace is crucial for temperature distribution, purity and energy consumption of high-temperature processes.

A typical construction of a metallic high-temperature furnace is disclosed, for example, by EP0303420(A1) and WO 2020/120147(A1).

A customary design in metallic high-temperature furnaces consists in a substantially cylindrical furnace jacket with a radiation shield formed therein along the circumference as what is called a side shield. The end faces are closed by means of covers. These covers likewise have a radiation shield. This shield is referred to as a cover shield or else, if the cover is designed in the form of doors, is referred to as a door shield. Typically, the support framework of the side shield is connected to the cylindrical portion of the body wall, and the support framework of the cover shield to the body cover. This is also analogously true of polygonal, for example rectangular, hot zones.

In a batchwise high-temperature furnace, the charge space has to be loaded and unloaded after each process cycle. Therefore, the hot zone generally has one or two covers (doors) that are opened and closed before and after each furnace run. In the case of a horizontal furnace with a cylindrical or cuboid working space, it is also often the case that a cover shield is secured to a pivotable door of the outer steel body. For loading and unloading, the door with the shield cover is opened so that the user has free access to the charge space. The closing of the door positions the shield cover with respect to the side shield such that the charge space is effectively shielded against heat losses. The aim here is to ensure that there is a minimum gap between cover shield and side shield in operation, but without direct contact, i.e. collision between the respective shields, since this can cause damage or deformation in the shields.

According to modern standard construction, the cover shield is secured by means of a support framework to securing bolts via threads through several steel bolts welded to the water-cooled door on a circular line. The correct distance between side shield and cover shield is adjusted uniformly over the circumference to a defined gap size in the cold state via the threaded bolts. This size is found from assumption or calculation of the thermal expansion of the various components of the hot zone when the furnace is heated to the maximum target temperature. The desired remaining gap in operation is a few mm (4 to 6 mm), in order to as far as possible prevent collision of the components.

A support framework for suspension (securing) of the cover shield on the cover of the body has to fulfill various functions and requirements:
bearing the weight of the shield
positioning the shield
adjustability of the gap between the cover shield and side shield
resistance to deformation at high temperatures and cyclical temperature loads
inexpensive design.

A particular challenge is the thermal expansions that occur during thermal cycling of the high-temperature furnace. The side shield, which is frequently fixed in the middle of the body, expands in length when the temperature increases, hence reducing the gap between side shield and cover shield. The cover shield secured to the body cover expands similarly (but to a much lesser degree) and reduces the gap further.

Consequently, in the cold state, the gap is adjusted such that it has its optimal size at a particular reference target temperature. Accordingly, during heating and cooling and in the case of temperatures other than maximum target temperature, the gap is accordingly larger or smaller than the optimum.

The weaknesses of current designs are as follows:

Shortcoming 1:

As described, the gap size changes depending on the operating temperature. An excessively large gap leads to additional energy losses and thermal stress on support framework components. A large gap causes further disadvantages in addition to the heat loss. For furnaces under gas atmosphere and for furnaces with rapid gas cooling, a gap constitutes a gas leak with a corresponding adverse effect on uniformity of temperature and atmosphere, and also cooling performance.

Shortcoming 2:

Modern suspension devices and support framework modules are of solid and rigid construction.

There is correspondingly major damage in the event of contact with sensitive and brittle components such as molybdenum shielding plates and bolts. A closed gap (i.e. contact between cover shield and side shield) therefore has to be absolutely avoided in order to prevent damage to the shields.

Shortcoming 3:

It is nowadays the case that the support framework of the cover shield is generally secured to the body cover by bolts connected rigidly and inseparably to the body cover, usually by welding.

In the event of a temperature rise, the cover shield expands significantly in area, while the body door itself remains cold due to water cooling. This accordingly gives rise to flexural stresses in the suspension bolts, which can lead to deformation and the fracturing of bolts over time in the case of brittle materials. In addition, because of the rigid fixing via bolts, the cover shield is subject to great forces on heating and cooling.

Shortcoming 4:

In order to prevent unwanted deformation and hence inadequate functionality in the cover shield because of the stress described in shortcoming 3 during its service life, the support framework is of very rigid and costly design. In addition to high manufacturing costs, material-intensive construction leads to high energy requirements and thermal inertia through heating of the correspondingly high masses.

It is an object of the present invention to eliminate or at least alleviate the shortcomings described above.

The object is achieved by a support framework for holding a cover shield having the features of claim 1.

Preferred developments are defined in the dependent claims.

The inventive design of the support framework so as to connect a cover shield to a body cover of a high-temperature furnace and keep the cover shield spaced apart from the body cover at a normal distance, and whereby the support framework has at least one holding element which is inclined at least in sections at an angle relative to a normal distance direction between cover shield and body cover, and is rotatable and/or flexible at least in sections, such that lateral expansion of the cover shield causes an increase in the angle and hence a reduction in the normal distance, achieves the effect of at least partly compensating for any change in a gap size between the cover shield and an expanding side shield.

The inventive configuration of the support framework brings about positive guidance of the cover shield in such a way that it is brought closer to the body cover under expansion. Thus, for example, a gap size between the cover shield and a side shield adjacent to it in an assembly can have narrower dimensions in a cold state than in the case of a conventional attachment of a cover shield to the body cover via rigid bolts.

It is possible by way of example and with preference through the invention to keep the gap size between the cover shield and an adjacent side shield constant over wide temperature ranges.

The shortcomings described above are eliminated by the invention.

The gap between the cover shield and side shield remains virtually constant with changing temperatures. This is achieved in that the cover shield is moved by the support framework of the invention in the direction of the body cover with rising temperature. This movement preferably corresponds to the thermal movement of the leading edge of the side shield at which the gap size with respect to the cover shield exists, in the direction of the cover shield. In the cooling operation, the cover moves correspondingly in the direction of the side shield, while the leading edge of the side shield moves in the same direction and keeps the gap constant.

In addition to the constant gap width during heating and cooling, the gap size is always the same and optimized at different holding temperatures. A high-temperature furnace equipped in this way is thus optimized not only for a single operating temperature.

Eliminating the problem of varying gap sizes leads to a reduction in energy losses, and the best possible uniformity of temperature and atmosphere with high process stability under a wide range of operating conditions.

The cover shield is secured to the body cover or the body door via flexible and/or rotatably mounted holding elements, which significantly reduces mechanical stresses compared to stiff bolts. This prevents wear and breakage of the holding elements and ensures sustained functionality. This is achieved by defined design of lengths and angles between the components, in particular by oblique positioning of the suspension elements in relation to the body door and door shield.

By means of preferably flexible suspension of the cover shield via elastically deflectable holding elements, the support framework can have a less rigid and complex design without occurrence of unwanted deformation. The new simplified design can be manufactured inexpensively, and reduction of mass leads to a reduction in energy requirement during heating and permits faster changes in temperature.

In the operation of a high-temperature furnace, the invention offers the following advantages in particular over the prior art:
increased energy efficiency
avoidance of leakage flows
avoidance of damage
lightweight design of the support framework

The invention can be applied both in the case of new constructions of high-temperature furnaces and in the case of replacement of a hot zone in an existing high-temperature furnace.

The invention is by no means limited to fully metallic hot zones. The invention is likewise suitable for graphite hot zones or for hybrid solutions with a combination of metallic shields and graphite and/or ceramic insulation layers.

When an existing cover shield is exchanged for a solution according to the invention, the geometries of the holding elements can be adapted to the given conditions, or additional securing adapters are used.

The holding elements that hold the cover shield on the body cover are typically made of steel. They may also be made of another thermally stable material. The holding elements, when designed as flexibly deflectable holding elements, must be sufficiently elastically deflectable to be able to accommodate the movements without plastic deformation. However, the dimensions of the holding elements must be such as to be able to bear the dead weight of the door shield in a safe and positionally exact manner. The skilled person is able to meet these design requirements by suitable choice of material, dimensions, material thicknesses and number of holding elements.

Other advantages of the invention include

### Increased Energy Efficiency

By virtue of the inventive design, gaps in shields can be made narrower, which leads to an increase in energy efficiency. The increase in efficiency results from an improved shielding effect by virtue of lower radiation losses through gaps. This increase in efficiency lowers operating costs via energy savings. In addition, a lowering of procurement costs can be expected since the power supply can be smaller owing to the lower power requirement.

### Avoidance of Leakage Flows

The gas flow in the hot zone is more controlled by virtue of the narrower gaps, and leakage flows through gaps are reduced. The reduced losses result in an improved approach of the cooling gas to the charge, which leads to an increase in the efficiency of cooling.

### Avoidance of Damage

If a fault occurs in that the gap between door shield and side shield is set too low or the hot zone is operated at too high a temperature, the result may be a collision between door shield and side shield. Even here, the invention offers an advantage over a conventional design since the support framework of the invention is designed to be more yielding and hence damage can be minimized even in the event of an unwanted collision.

The geometry and flexibility of the support framework of the invention additionally prevent problematic flexural stresses in the suspension elements, which used to frequently lead to plastic deformation, extending as far as material fracture.

### Lightweight Design of the Support Framework

In the conventional solution, expansion of the door shield (especially the support framework) leads to high flexural stresses in the bolts and correspondingly high stresses in the door shield. In order to prevent damage and unwanted deformation in the door shield, the support framework is conventionally very rigid and solid.

By virtue of the inventive suspension by means of holding elements with at least rotatable and/or flexible sections, the support framework can be made much less complex and lighter. This results in cost benefits in the course of production, permanently deformation-free operation and benefits in the furnace process, since less mass has to be heated and cooled.

In a comparison of construction by the applicant, dispensing with tangential bracing and costly welded joints resulted in a cost saving of about 20% compared to conventional construction.

Typical dimensions of furnace types for which the invention can be used particularly fruitfully are a diameter of 30 cm to 3 m for the cover shield. A length of the furnace is typically between 30 cm and 5 m. The invention can also be employed in rectangular furnaces.

The invention is indeed also utilizable for smaller furnaces or ovens, for example laboratory ovens. The savings are correspondingly smaller.

Preferred developments of the invention are described in detail hereinafter: The angle between the normal distance direction and the at least partial inclination of the holding element is preferably between 5° and 85°. The angle is further preferably within a range between 10° and 80°. The angle is even further preferably within a range between 15° and 75°. In particular, the angle is within a range between 40° and 50°.

The angle is defined between holding element and normal distance direction, where zero degrees corresponds to an orientation parallel to normal distance direction.

If a holding element is not designed as a straight strut but has a curved shape at least in sections, for example, an average inclination of a holding element can be determined by setting that angle which is formed between an imaginary straight connection of the securing points to cover shield and the body cover and normal distance direction.

If there are several holding elements, it is not absolutely necessary for all of them to form the same angle to normal distance direction. However, for the purposes of a modular design using identical parts, it is preferable that all holding elements form the same angle to normal distance direction.

Excessively steep alignment of the holding elements (corresponding to a small angle) may lead to undesirably high axial stiffness.

In the case of too flat an alignment of the holding elements (corresponding to a large angle), the result may be overcompensation, corresponding to an unwanted increase in gap size. The angle has to be matched to the length of the side shield.

It is preferably the case that at least sections of at least two holding elements are inclined. There are generally significantly more, for example four to ten, holding elements, depending on the size of the cover shield. It is advantageously the case that the holding elements are spaced uniformly along a circumference of the cover shield.

It is preferably the case that holding elements disposed opposite one another with respect to a central axis that runs normal to the cover shield have opposite inclinations with respect to the normal distance direction. What is meant and intended by “opposite” inclination of the holding elements is that the (tensile) forces induced by the expansion of the cover shield in the holding elements, in particular the radial component of these forces, cancel each other out. This prevents lateral movement or tilting of the cover shield.

The axial component of the induced forces in the holding elements leads to the described effect that expansion of the cover shield causes it to move closer in the body cover direction.

“Opposite” does not necessarily mean that the holding elements are mirror-symmetrical with respect to a central axis.

The aim is instead that the radial components (i.e. those that are perpendicular to the normal distance direction) of the forces in the holding elements cancel each other out. The cover shield then performs a translational movement in the direction of the body cover as it expands.

It may be the case that the securing points of a holding element to cover shield and body cover are not in the same plane containing the central axis. This configuration can be imagined in that cover shield and body cover are twisted relative to one another about the central axis. The cover shield then performs a translational movement in the direction of the body cover and additionally a rotation about the central axis on expansion.

The securing points of the holding elements arranged about a central axis on the cover shield side are preferably radially further outward and extend further radially inward in the body cover direction.

It is preferably the case that the holding element or a plurality of holding elements is/are rotatably mounted via an articulated joint relative to the cover shield and/or the body cover. The holding element may be designed, for example, as a strut connected via simple hinges, for instance via pins, to the cover shield and/or the body cover and is rotatably mounted. The articulated joint allows variation in the inclination of the holding elements on expansion of the cover shield.

Alternatively or additionally, it may be the case that one or more holding elements are designed to be elastically deflectable. In this execution, it is made possible for the inclination of the holding elements to be varied when the cover shield expands via elastic deflection of the holding elements.

It may be the case that the support framework has a guide element movable in a direction of movement. In particular, the direction of movement of the guide element corresponds to normal distance direction.

Such a design of guide element can possibly achieve improved guidance of the movement of the cover shield in the cover direction. The guide element may, for example, be designed as a telescopic guide of movable cylinders. Also conceivable are mutually displaceable, intermeshing profiles, which form a kind of telescopic rail.

Protection is also sought for an arrangement comprising a cover shield for a high-temperature furnace with a support framework of the invention and for a high-temperature furnace with a support framework of the invention.

The invention is particularly directed at applications with process temperatures of more than 900 °C. Since radiation losses rise exponentially with temperature, the advantages of the invention are perceptible at high temperatures in particular.

The invention is intended in particular for metallic shields. Metallic shields consist of a substantially parallel arrangement of spaced-apart radiation plates. These are preferably made of refractory metal, especially tungsten or molybdenum and alloys thereof.

High-temperature furnaces of this design are used in particular for heat treatments above 900 °C. In particular, the invention is intended for high-temperature furnaces designed for a target temperature of >1200 °C, in particular >1500 °C, up to target temperatures in the region of 2500 °C. Such high-temperature furnaces are used, for example, for sintering of refractory metals, in particular of molybdenum or tungsten base materials, for growth of single sapphire crystals for LED production, for soldering, for heat treatment of turbine components, etc.

Because the insulation takes the form of metallic shields, particularly clean process conditions can be achieved. Depending on the design, operation under protective gas atmosphere or reduced pressure is possible.

Protection is sought for a support framework for holding a cover shield for a high-temperature furnace, wherein the support framework is designed to connect the cover shield to a cover of the high-temperature furnace and keep the cover shield spaced apart from the cover at a normal distance, and the support framework has at least one holding element which is inclined at least in sections at an angle relative to a normal distance direction between cover shield and cover, and is rotatable and/or flexible at least in sections, such that lateral expansion of the cover shield causes an increase in the angle and hence a reduction in the normal distance.

It is preferably the case that the angle between the normal distance direction and the at least partial inclination of the holding element is between 5°and 85°.

It is preferably the case that at least sections of at least two holding elements are inclined.

It is preferably the case that holding elements disposed opposite one another with respect to a central axis that runs normal to the cover shield have opposite inclinations with respect to the normal distance direction.

It is preferably the case that at least one holding element is rotatably mounted via an articulated joint relative to the cover shield and/or the cover.

It is preferably the case that at least one holding element is elastically deflectable.

It is preferably the case that the support framework has a guide element movable axially in normal distance direction.

Protection is also sought for an arrangement comprising a cover for a high-temperature furnace with a support framework as described above, and for a high-temperature furnace with a support framework as described above.

As already set out, a radiation shield of a high-temperature furnace generally comprises a cover shield and a side shield.

The foregoing explanations for the support framework for holding a cover shield are correspondingly applicable, where appropriate, to side shields as well.

Analogously to the support framework for holding a cover shield, protection is sought for a support framework for holding a side shield, wherein the support framework is designed to connect the side shield to a wall of a high-temperature furnace and keep the side shield spaced apart from the wall at a normal distance, and the support framework has at least one holding element which is inclined at least in sections at an angle relative to a normal distance direction between side shield and wall, and is rotatable and/or flexible at least in sections, such that lateral expansion of the side shield causes an increase in the angle and hence a reduction in the normal distance.

By virtue of application to side shields, it is possible to reduce the size of a gap between adjacent side shields in the cold state, and such a gap size is not only closed by thermal expansion. Analogously to the application to cover shields, the thermal expansion of side shields in circumferential direction (more specifically, thermal expansion in the direction of a secant of the polygon formed by the side shields) translates into a movement in radial direction. This deflection in radial direction has the effect that the gap between the segments is kept virtually constant.

Further advantages and benefits of the invention will be apparent from the description of working examples that follows, with reference to the appended figures.

The figures show:

FIGS. 1a and 1b: a schematic of a high-temperature furnace according to the prior art

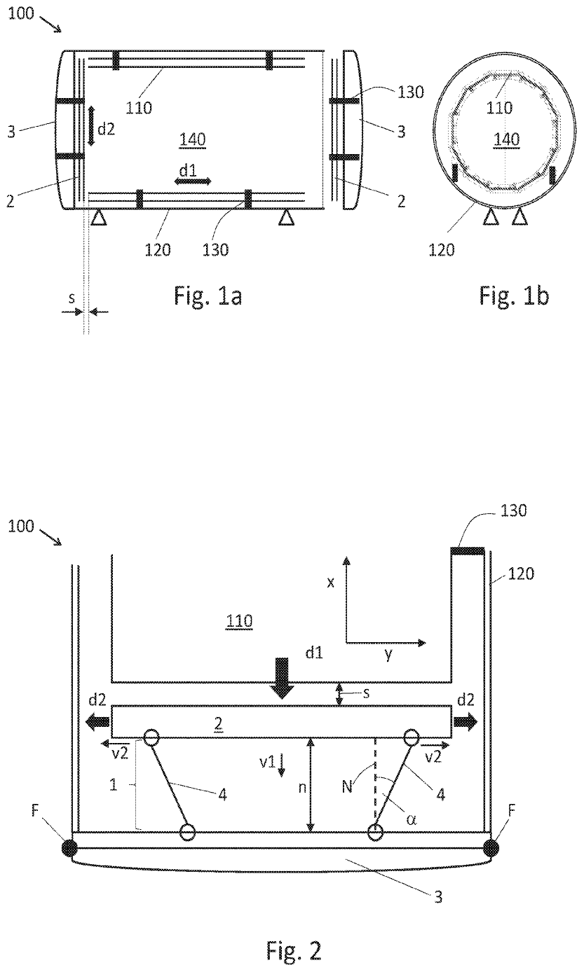

FIG. 2: an arrangement comprising a support framework of the invention

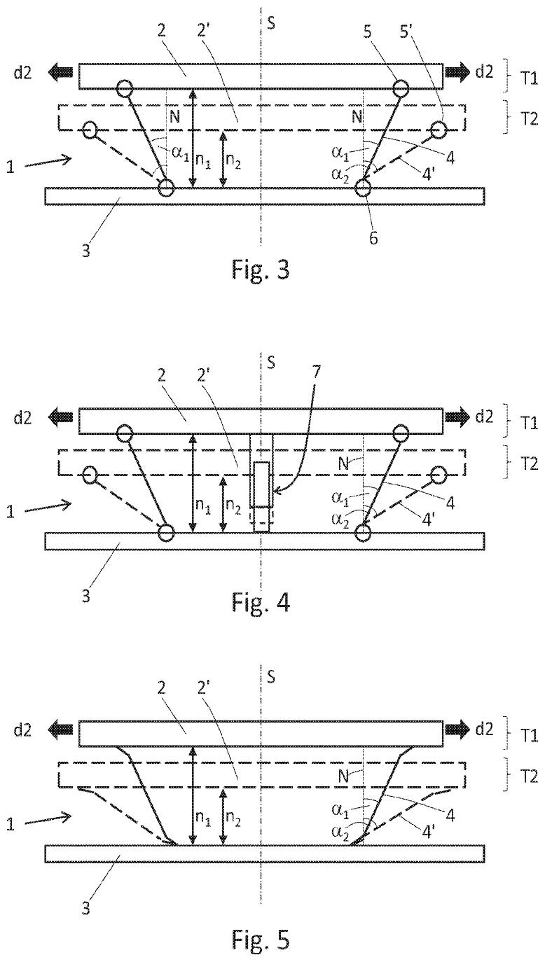

FIG. 3: a support framework of the invention in a first working example

FIG. 4: a further working example of the invention

FIG. 5: a further working example of the invention

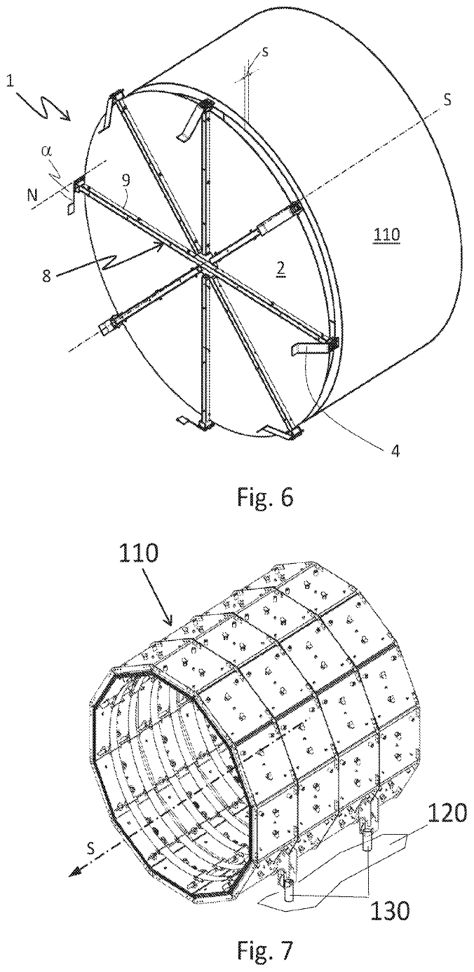

FIG. 6: a further working example of the invention

FIG. 7 an example of a side shield

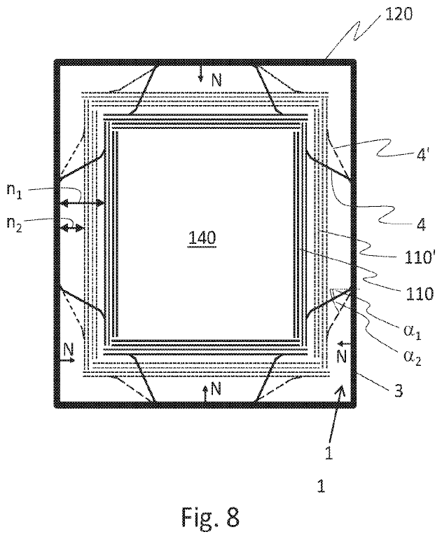

FIG. 8 an example of a side shield with compensation of gap size under thermal expansion.

FIGS. 1a and 1b show a schematic, for basic orientation, of a high-temperature furnace 100 according to the prior art, where FIG. 1 a shows a schematic longitudinal section and FIG. 1 b a schematic cross section.

This example shows a cylindrical furnace shape in a recumbent (horizontal) design.

The high-temperature furnace 100 comprises a furnace jacket 120, also called body, which is generally designed as a steel shell and is typically water-cooled.

The high-temperature furnace 100 is closable at the end faces by covers 3. The high-temperature furnace 100 comprises a process space 140 which is insulated with respect to the furnace jacket 120 by a side shield 110. In the covers 3, cover shields 2 insulate the process space 140.

This is illustrated in that the cover 3 of the right-hand end face is shown spaced apart from the high-temperature furnace 100 in this diagram. For example, the cover 3 can be designed as a pivotable door.

The high-temperature furnace 100 is designed in particular as a metallic furnace. The shields 2, 110 typically take the form of packages of mutually spaced metal sheets. In particular, the shields are formed from refractory metals, especially from molybdenum or tungsten or alloys thereof.

As shown in FIG. 1b, the side shield 110 is formed as a circular cylinder around the process space 140, but the side shield may also consist of a polygonal chain of several interconnected shielding modules. In the example shown, a virtually circular cross section is achieved. Alternatively, for example, a rectangular cross section could also be formed by shielding modules perpendicular to one another.

The shields 2, 110 shown in FIG. 1a are suspended from bolts 130 welded to the cover 3 and the furnace jacket 120 respectively. In this conventional execution, the cover shield 2 is screwed firmly to bolts 130, and these bolts 130 are in turn fixedly welded to the cover 3 (here designed as a body door).

Similarly, the side shield 110 is connected to the furnace jacket 120 via bolts 130.

Thermal expansion of the shields 2, 110 is at least partly stopped by the rigid fastening and causes high flexural stresses in the bolts 130.

When the process space 140 is heated, the length of the side shield 110 (shown by block arrow d1) increases as a result of thermal expansion. The cover shield 2 expands predominantly in the lateral direction illustrated by block arrow d2.

In addition to the thermal expansions along the shields 2, 110 in the direction of the respective planes, there is a lesser extent of thermal expansion of the bolts 130 that bear the shields 2, 110.

In particular, the thermal expansion of the side shield 110 in the direction of block arrow d1 and (to a lesser extent) the thermal expansion of the bolts bearing the cover shield 2 causes a change in a gap size—s—between the cover shield 2 and the side shield 110.

The gap size—s—is set in a cold state such that it has the optimum size at a certain maximum target temperature. During heating and cooling and at temperatures at variance from the maximum target temperature, the gap size—s—is accordingly greater or smaller than the optimum. This is associated with the disadvantages discussed at the outset.

FIG. 2 shows a schematic of an inventive support framework 1 for holding a cover shield 2, here in an assembly with a side shield 110, shown in sections, of a high-temperature furnace 100.

The support framework 1 connects the cover shield 2 to the cover 3 and keeps it spaced apart from the side shield 110 at a gap size—s.

The support framework 1 has at least one holding element 4 that extends between the cover 3 and the cover shield 2.

Between the side shield 110 and the cover shield 2, there is a normal distance—n—in a normal distance direction N. In the inventive support framework 1, the holding element 4 has an inclination to an angle α with respect to normal distance direction N, where the angle α is not zero.

Preferably, the angle α is within a range between 5°and 85°.

Further preferably, the angle α is within a range between 10°and 80°.

Even further preferably, the angle α is within a range between 15°and 75°. In particular, the angle α is within a range between 40°and 50°.

If thermal expansion of the side shield 110 in the direction shown by block arrow d1 then occurs owing to heating, in a conventional design of a suspension of the cover shield 2 via a rigid bolt connection along the normal distance N, the gap size—s—would decrease as already described for FIG. 1a.

However, by virtue of the support framework 1, in accordance with the invention, having a holding element 4 inclined relative to normal distance direction N and the holding element 4 being at least partly rotatable and/or flexible, the lateral thermal expansion of the cover shield 2 that occurs (along block arrow d2) can advantageously be utilized to compensate for the change in the gap size—s.

For easier understanding of the movements that occur, the fixed points F with respect to cover 3 and the bolt 130 for the side shield 110 can be assumed to be fixed points with regard to the x axis drawn by way of assistance. The thermal expansion of the cover shield 2 causes a movement v1 of the cover shield 2 in (negative) x direction by virtue of the support framework 1 designed in accordance with the invention. The size of the movement v1 of the cover shield 2 is found from the lateral movement v2 of the cover shield 2 and the dimensions of the holding elements 4 and the angle α according to the angular function.

The change in gap size—s—is found from the movement v1 of the cover shield n (negative) x direction and the extent of the expansion of the side shield 110 in the direction of expansion—d1—of the side shield 110.

The geometric ratios are chosen such that the gap size—s—remains very substantially the same for all operating temperatures and in the ideal order of magnitude of a few mm, especially in the case of very high furnace temperatures, in order to keep radiation losses low.

The mode of action is elucidated in detail by FIG. 3.

FIG. 3 illustrates the kinematics of the inventive support framework 1 in a first working example.

The support framework 1 bears a cover shield 2 for a high-temperature furnace (high-temperature furnace not shown) via holding elements 4 and connects the cover shield 2 to a cover 3. The view in FIG. 3 shows two holding elements 4. Depending on their construction and size, several holding elements 4 may also be provided. For example, at least three holding elements 4 may be formed in the case of a circular cover 3.

Two positions of the support framework 1 are shown:
by solid lines, the position at a temperature T1
by dashed lines, the position at a temperature T2,
   with temperature T2 greater than temperature T1.

For example, temperature T1 is the ambient temperature and temperature T2 is an operating temperature of a high-temperature furnace.

At temperature T1, the cover shield 2 is spaced apart from the cover 3 with a first normal distance n₁. In relation to a normal distance direction—N—between cover shield 2 and cover 3, a holding element 4 assumes a first angle α₁. In other words, the holding element 4 does not extend normally (perpendicular) to the cover shield 2 and cover 3 as in the bolts known from the prior art, but is inclined at least in sections.

Normal distance direction—N—in this example is a normal to cover shield 2 and cover 3.

In the case of a form of cover shield 2 and/or cover 3 in a non-flat shape, the normal distance direction N used may be the direction of a local shortest connection.

In the present example, two holding elements 4 are shown, disposed opposite one another with regard to a central axis—S. In the present context, the two holding elements 4 are advantageously in a symmetric arrangement to the At temperature T2, the cover shield 2′ is spaced apart from the cover 3 over a second normal distance central axis—S.

The opposite holding elements 4 each form a first angle α₁ to the normal distance direction—N; in this working example, the angle has the same magnitude, but the holding elements 4 have opposite inclinations.

When the temperature rises from temperature T1 to temperature T2, the lateral thermal expansion of the cover shield 2 (along block arrow d2) causes an increase in size of the deflection of the two holding elements 4 in this diagram. At temperature T2, the holding elements 4 each assume a second angle α₂ to normal distance direction—N, where the magnitude of the second angle α₂ is greater than the magnitude of the first angle α₁.

Lateral expansion of the cover shield 2 means expansion perpendicular to a surface normal of the cover shield 2.

Because the holding elements 4 are at least partly rotatable and/or flexible, the holding elements 4 permit lateral expansion of the cover shield 2 and—unlike rigid bolts—guide it into a second position, shown in dashed lines as cover shield 2′.

n₂, where the second normal distance n₂ is smaller than the first normal distance n₁.

In the present working example, the holding elements 4 are movably connected to the shield 2 and the cover 3 via articulated joints 5 on the shield side and articulated joints 6 on the cover side.

The inventive support framework 1 has the effect that, in the event of heating and the associated thermal expansion of the cover shield 2, the latter moves closer to the cover 3. A change in a gap size with respect to a side shield extending in the direction of the cover shield 2 (not shown here) can be at least partially compensated for thereby.

Explained in other words, the support framework 1 comprising at least one holding element 4 inclined relative to normal distance direction N is such that the forces induced by thermal expansion of the cover shield 2 cause increased deflection of the at least one holding element 4. Since—in this working example—free movement of the holding element 4 is blocked by an opposite holding element 4 with opposite inclination, the normal distance is reduced without movement of the cover shield 2 relative to the central axis—S. The cover shield 2 thus preferably performs a parallel movement in the direction of cover 3 when the temperature rises.

In the preferred case, the support framework 1 is configured such that the gap size remains constant over a temperature range between room temperature and the operating temperature of a high-temperature furnace.

For this purpose, the skilled person is able to design the holding elements 4 by means of numerical simulation of the thermal expansions and tests.

It will be apparent that the holding elements 4 are also subject to thermal expansion. However, this is small in comparison to the lateral expansion of the cover shield 2 and in no way nullifies the effect of the arrangement of the invention.

In the case of a vertical design of a high-temperature furnace, meaning a recumbent arrangement of the cover shield 2, the holding elements 4 are subject to similar gravitational load. One option is a design of the holding elements 4 in which holding elements 4 are arranged uniformly over a circumference relative to the central axis—S.

In a recumbent (horizontal) design of a high-temperature furnace, it may be advantageous to arrange the holding elements 4 relative to the central axis—S—in such a way that the influence of gravity does not lead to lowering of the cover shield 2 relative to the central axis—S. The lowering of the cover shield 2 can also be avoided by skillful sizing of the holding elements 4.

FIG. 4 shows a further working example of the support framework 1. The reference signs introduced for FIG. 3 are not described again. The diagram makes use of the elucidations relating to the different positions of the holding elements 4 as a function of the temperature from FIG. 3.

In this case, the design of the holding elements 4 is unchanged compared to FIG. 3. In addition, however, a guide element 7 is provided, which is movable axially in the direction of the central axis—S—and is rigid transverse thereto.

The central axis—S—here and preferably is parallel to normal distance direction N. The guide element 7 may, for example, be formed telescopically by an arrangement of a hollow cylinder with a cylinder movably mounted therein. In the present example, for instance, a cylinder is formed on the side of the cover 3 and extends into a hollow cylinder fixed at the side of the cover shield 2.

In this working example, the guide element 7 prevents the cover shield 2 from evading with respect to the central axis—S.

In this way, only an inclined holding element 4 would be required to achieve the inventive effect of the support framework 1. In practice, several holding elements 4 along a circumference of the cover shield 2 are preferable solely because of a desired uniform introduction of force.

FIG. 5 shows a further working example of the invention.

For the basic principle and the reference signs, reference is made to FIG. 3. The deflection of the holding elements 4 is achieved here in the case of an expansion of the cover shield 2 in that the holding elements 4 are flexible. The function of the pivot points is assumed here by chamfers in the holding elements 4, which have a spring effect as a result. The holding elements 4 may be formed, for example, as chamfered sheet metal strips that are fixed, for example, to the cover shield 2 and to the cover 3 via a rivet or screw connection or a weld bond.

It will be apparent that the variants shown in the working examples are freely combinable with one another.

For example, flexible holding elements 4 can be combined with articulated holding elements 4 on a support framework 1. It is also conceivable to additionally equip flexible holding elements 4 with articulated joints 6. Moreover, one or more guide elements 7 may additionally be provided.

FIG. 6 shows a further working example of the invention.

What is shown is a perspective view of a support framework 1 with a cover shield 2 and an adjoining side shield 110.

The diagram corresponds to an arrangement for a cylindrical furnace type in a recumbent design here.

Eight holding elements 4 are arranged at equal distances along a circumference of the cover shield 2. With respect to the central axis—S—opposing holding elements 4 have an opposite progression.

The holding elements 4 extend at an angle from the cover shield 2 in the direction of the cover (not shown) with respect to the central axis—S—toward the inside.

In the case of an odd number of holding elements 4, the holding elements 4 are naturally not opposite one another in a mirror-symmetric manner with respect to the central axis—S. As already elucidated, opposing holding elements 4 have an opposite progression. In the present example, the holding elements 4 lead from further outward on the cover shield 2 in the inward direction toward the cover (not shown).

The ends of the holding elements 4 remote from the cover shield 2 are designed for fixing to a cover (not shown). The holding elements 4 are of flexible design in the present context as chamfered sheet metal strips. A support frame 8 with radially extending struts 9 (eight of them here) is provided for stiffening and power transmission. The holding elements 4 engage radially on the outside of the struts 9 of the support frame.

An additional advantage of the design of the holding elements 4 as flexible sheet metal strips is that they are deflectable similarly to leaf springs but are stiff transverse to the intended direction of movement. In this way, rigid mounting of the cover shield 2 is assured.

The construction principle of the support framework 1 comprising a support frame 8 is generally suitable for the implementation of the invention.

In an assembly, the cover shield 2 would be connected to a cover, and the side shield 110 to a furnace jacket.

When the side shield 110 expands in the event of an increase in temperature, the gap size—s—between side shield 110 and cover shield 2 remains constant because of the support framework 1 of the invention.

The embodiments of the present working example are combinable with the previously discussed variants and are by no means limited to this working example.

FIG. 7 shows an example of a side shield 110 constructed from individual shielding modules. The side shield 110 is connected via bolts 130 to a furnace jacket 120 (merely indicated).

FIG. 8 shows an application of the support framework described above for cover shields on side shields 110 of a high-temperature furnace 100 in a cross section normal to a longitudinal axis of the high-temperature furnace 100. In the present case, an arrangement of four planar side shields 110 is shown, which surround a process space 140 of square cross section. The side shields 110 are connected to a furnace jacket 120 via a support framework 1. Instead of a direct connection to the furnace jacket 120, it would be possible to provide a support structure to which the support framework 1 connects.

As already described above, the support framework 1 comprises holding elements 4 which connect a side shield 110 to the furnace jacket 120 and keep the side shield 110 spaced apart from the furnace jacket 120 with a normal distance n.

At least sections of the holding elements 4 extend at an angle with respect to a respective normal distance direction N such that a lateral expansion of the side shields 110 causes an increase in the angle α and hence a reduction in normal distance n.

In the present arrangement, the support framework 1 in this form achieves the effect that a gap size between adjacent side shields 110 is kept essentially constant on thermal expansion of the side shields 110. With conventional rigid suspensions of side shields, for instance via rigid bolts, such a large gap size is chosen for the cold state that this is closed only by the thermal expansion, with the proviso that the side shields do not collide.

Because of the support framework 1, it is already possible in the present case to choose a narrow gap size in the cold state. This reduces thermal losses.

Two positions of the support framework 1 are shown:
by solid lines, the position at a temperature T1
by dashed lines, the position at a temperature T2,
   with temperature T2 greater than temperature T1.

For example, temperature T1 is the ambient temperature and temperature T2 is an operating temperature of a high-temperature furnace.

When heated, the side shields 110 (position at temperature T1) undergo lateral expansion, as shown by the side shields 110′ at temperature T2. The expansion causes deflection of the holding elements 4 from a first angle α1 (at temperature T1) to a second angle α2 (temperature T2).

It is apparent that the gap size between adjacent side shields 110 remains constant due to this design of the support framework 1. Elucidations given above in respect of the support framework on the cover shield 2 shall also apply correspondingly to side shields 110, where applicable.

1-10. (canceled)

11. A support framework for holding a radiation shield for a high-temperature furnace, the support framework configured to connect the radiation shield to a wall of the high-temperature furnace and to keep the radiation shield spaced apart from the wall at a normal distance, the support framework comprising:
at least one holding element inclined at least in sections at an angle relative to a normal distance direction between the radiation shield and the wall;
said at least one holding element being at least one of rotatable or flexible at least in sections, permitting a lateral expansion of the radiation shield to cause an increase in the angle and therefore a reduction in the normal distance.

12. The support framework according to claim 11, wherein the angle between the normal distance direction and the inclination of the holding element at least in sections is between 5°and 85°.

13. The support framework according to claim 11, wherein said at least one holding element includes at least two holding elements being inclined at least in sections.

14. The support framework according to claim 11, wherein said at least one holding element includes holding elements disposed opposite one another relative to a central axis running normal to the radiation shield, said holding elements having opposite inclinations relative to the normal distance direction.

15. The support framework according to claim 11, wherein said at least one holding element is rotatably mounted at an articulated joint relative to at least one of the radiation shield or the wall.

16. The support framework according to claim 11, wherein said at least one holding element is elastically deflectable.

17. The support framework according to claim 11, which further comprises a guide element being movable axially in the normal distance direction.

18. An arrangement, comprising the cover for the high-temperature furnace, and the support framework according to claim 11.

19. An arrangement, comprising the wall for the high-temperature furnace being a side wall, and a support framework according to claim 11.

20. A high-temperature furnace, comprising the support framework according to claim 11.
